(19) United States
(12) Patent Application Publication
(10) Pub. No.: US 2006/0163879 A1
(43) Pub. Date: Jul. 27, 2006

(54) Engine driven power supply device

(75) Inventors: Tomoaki Sekita, Numazu-shi (JP); Kazuyoshi Kishibata, Numazu-shi (JP); Yuichi Kitagawa, Numazu-shi (JP); Hiroyasu Sato, Numazu-shi (JP)

Correspondence Address: PEARNE & GORDON LLP, 1801 EAST 9TH STREET, SUITE 1200, CLEVELAND, OH, 44114-3108, US

(73) Assignee: Kokusan Denki Co., Ltd., Numazu-shi (JP)

(21) Appl. No.: 11/334,903

(22) Filed: Jan. 19, 2006

(30) Foreign Application Priority Data
Jan. 21, 2005 (JP) 2005-14494

(51) Int. Cl. H02P 9/00

(52) U.S. Cl. 290/41; 290/40 B

(57) ABSTRACT

An engine driven power supply device in which a load connecting receptacle is connected, via a connector, to an output end of a power supply device body that outputs power required for driving a load using a generator driven by an engine as a power supply, wherein a connector state detection switch that holds an OFF state when the connector is separated and holds an ON state when the connector is connected is provided in the connector, the connector state detection switch is inserted between an ignition for the engine and an exciter coil that provides a power supply voltage to the ignition device so that an operation of the ignition device is stopped when the connector is separated.

### TECHNICAL FIELD OF THE INVENTION

The present invention relates to an engine driven power supply device that supplies power to a load using a generator driven by an engine as a power supply.

### BACKGROUND OF THE INVENTION

Engine driven power supply devices include an engine generator that supplies commercial AC power to a load using a generator driven by an engine as a power supply as disclosed in Japanese Patent Application Laid-Open Publication No. 2001-15937 or an engine welder that supplies power to a welding load using a generator driven by an engine as a power supply as disclosed in Japanese Patent Application Laid-Open Publication No. 2004-276115.

Such a power supply device includes a power supply device body that outputs power required for driving a load and a load connecting receptacle connected to an output end of the power supply device body via a connector, and supplies power from the power supply device body to the load via the connector, the receptacle, and a plug connected to the receptacle.

In some cases, the power supply device body is comprised of a generator itself driven by an engine, and in other cases, the power supply device body is comprised of a generator driven by an engine, a converter that converts an output of the generator into an DC output, and an inverter that converts the DC output obtained from the converter into an AC output at a fixed frequency. In further cases, the power supply device body is comprised of a generator driven by an engine and a cyclone converter that directly converts an AC output of the generator into an AC output at a fixed frequency.

In the engine driven power supply device comprised as described above, if the connector provided between the output end of the power supply device body and the receptacle is separated by vibrations of the engine or an external impact or the like during an operation, conductive components around a terminal to which a voltage of the connector is applied may come into contact with the terminal to cause electrical leakage or electrical shocks. For higher safety, it is preferable to eliminate the risk of electrical leakage or electrical shocks.

In the conventional engine driven power supply device, the operation of the engine is continued even with the connector being separated, and thus the operation of the engine may be continued in a state where the load cannot be driven to waste energy.

### SUMMARY OF THE INVENTION

An object of the present invention is to provide an engine driven power supply device that can eliminate the risk of electrical leakage or electrical shocks and continued wasting of energy when a connector provided between an output end of a power supply device body and a receptacle is separated by vibrations or the like.

The present invention is applied to an engine driven power supply device including: a power supply device body that outputs power required for driving a load using a generator driven by an engine as a power supply; and a load connecting receptacle connected to an output end of the power supply device body via a connector.

In the present invention, a connector state detection switch that enters different states between when the connector is separated and when the connector is connected is provided in the connector, and electrical equipment required for maintaining an operation of the engine and the connector state detection switch are connected so that the function of the electrical equipment is stopped when the connector is separated.

Comprised as described above, the electrical equipment required for maintaining the operation of the engine stops the operation thereof to stop the engine, thereby stopping an output of the generator when the connector is separated. This prevents electrical leakage or electrical shocks when the connector is separated and a terminal thereof is exposed, thereby improving safety. Further, the engine is stopped with the connector being separated, thereby preventing energy from being wasted in a state where the load cannot be driven.

In a preferable aspect of the present invention, a connector state detection switch that holds an OFF state when the connector is separated and holds an ON state when the connector is connected is provided in the connector. In this case, wiring required for holding electrical equipment required for maintaining an operation of the engine in an operation state and the connector state detection switch are connected so that the connector state detection switch is inserted in the middle of the wiring, and the function of the electrical equipment required for maintaining the operation of the engine is stopped when the connector state detection switch is in the OFF state.

The electrical equipment required for maintaining the operation of the engine includes electrical equipment whose operation is stopped to stop the engine, such as an ignition device that ignites the engine or a fuel injection device that supplies fuel to the engine.

In a preferable aspect of the present invention, the electrical equipment is an ignition device that ignites the engine, and the wiring into which the connector state detection switch is inserted is any of wiring that provides an electrical signal including crank angle information of the engine to the ignition device, wiring for supplying a power supply voltage to the ignition device, and wiring for passing a primary current through an ignition coil of the ignition device.

In another preferable aspect of the present invention, a connector state detection switch that holds an ON state when the connector is separated and holds an OFF state when the connector is connected is provided in the connector. In this case, electrical equipment required for maintaining an operation of the engine and the connector state detection switch are connected so that a component of the electrical equipment is short-circuited via the connector state detection switch when the connector state detection switch is in the ON state, and the function of the electrical equipment is stopped when the connector state detection switch is in the ON state.

When the electrical equipment is an ignition device that ignites the engine, the component short-circuited via the connector state detection switch is, for example, a signal source that generates an electrical signal including crank angle information of the engine.

When the electrical equipment is the ignition device that ignites the engine, the component short-circuited via the connector state detection switch may be an ignition power supply that supplies a power supply voltage to the ignition device.

In a further preferable aspect of the present invention, a connector state detection switch that holds an OFF state when the connector is separated and holds an ON state when the connector is connected is provided in the connector, and an ignition allowing signal generation circuit that generates an ignition allowing signal when input terminals of the circuit are short-circuited is provided. An ignition device that ignites the engine is comprised so as to function (perform an ignition operation) when the ignition allowing signal is generated. In this case, the connector state detection switch is connected between the input terminals of the ignition allowing signal generation circuit, and the input terminals of the ignition allowing signal generation circuit are short-circuited to generate the ignition allowing signal only when the connector is connected.

In a further preferable aspect of the present invention, a connector state detection switch that holds an OFF state when the connector is separated and holds an ON state when the connector is connected is provided in the connector, and an ignition allowing signal generation circuit that generates an ignition allowing signal only when an input terminal is connected to a ground circuit is provided. Further, an ignition device that ignites the engine is comprised so as to function only when the ignition allowing signal is generated, and the input terminal of the ignition allowing signal generation circuit is connected to the ground circuit via the connector state detection switch.

Also, in the case where a connector state detection switch that holds an ON state when the connector is separated and holds an OFF state when the connector is connected is provided in the connector, an ignition device may be comprised so as to perform an ignition operation only when an ignition allowing signal is generated, thereby allowing the ignition operation only when the connector is connected, and preventing the ignition operation when the connector is separated.

In this case, the ignition allowing signal generation circuit is comprised so as to generate the ignition allowing signal when input terminals are open-circuited, the connector state detection switch is connected between the input terminals of the ignition allowing signal generation circuit, and the input terminals of the ignition allowing signal generation circuit are open-circuited when the connector is connected.

In the case where the connector state detection switch that holds the ON state when the connector is separated and holds the OFF state when the connector is connected is provided in the connector as described above, the ignition allowing signal generation circuit may be comprised so as to generate an ignition allowing signal when an input terminal is separated from a ground circuit and stop the generation of the ignition allowing signal when the input terminal is connected to the ground circuit, and the input terminal of the ignition allowing signal generation circuit may be connected to the ground circuit via the connector state detection switch.

As described above, also in the case where the ignition allowing signal generation circuit that generates the ignition allowing signal when the connector is connected and stops the generation of the ignition allowing signal when the connector is separated is provided so that the ignition device functions only when the ignition allowing signal is generated, the engine can be stopped when the connector is separated. This prevents electrical leakage or electrical shocks when the connector is separated and the terminal thereof is exposed, and prevents energy from being wasted.

As described above, according to the present invention, the operation of the electrical equipment required for maintaining the operation of the engine when the connector is separated is stopped to stop the engine, thereby stopping the output of the generator. This prevents electrical leakage or electrical shocks when the connector is separated by vibrations or the like of the engine, thereby improving safety, and prevents energy from being wasted.

### BRIEF DESCRIPTION OF THE DRAWINGS

The above and other objects and features of the invention will be apparent from the detailed description of the preferred embodiment of the invention, which are described and illustrated with reference to the accompanying drawings, in which;

FIG. 1 is a circuit diagram showing a construction of a first embodiment of the present invention;

FIG. 2 is a circuit diagram showing an example of a circuit construction of an ignition device used in the embodiment in FIG. 1;

FIG. 3 is a circuit diagram showing a construction of a second embodiment of the present invention;

FIG. 4 is a circuit diagram showing a construction of a third embodiment of the present invention;

FIG. 5 is a flowchart showing an operation of an ignition allowing signal generation circuit used in the embodiment in FIG. 4;

FIG. 6 is a circuit diagram showing a construction of a fourth embodiment of the present invention;

FIG. 7 is a flowchart showing an operation of an ignition allowing signal generation circuit used in the embodiment in FIG. 6;

FIG. 8 is a circuit diagram showing a construction of a fifth embodiment of the present invention; and

FIG. 9 is a circuit diagram showing a construction of a sixth embodiment of the present invention.

### DETAILED DESCRIPTION OF THE PREFERRED EMBODIMENTS

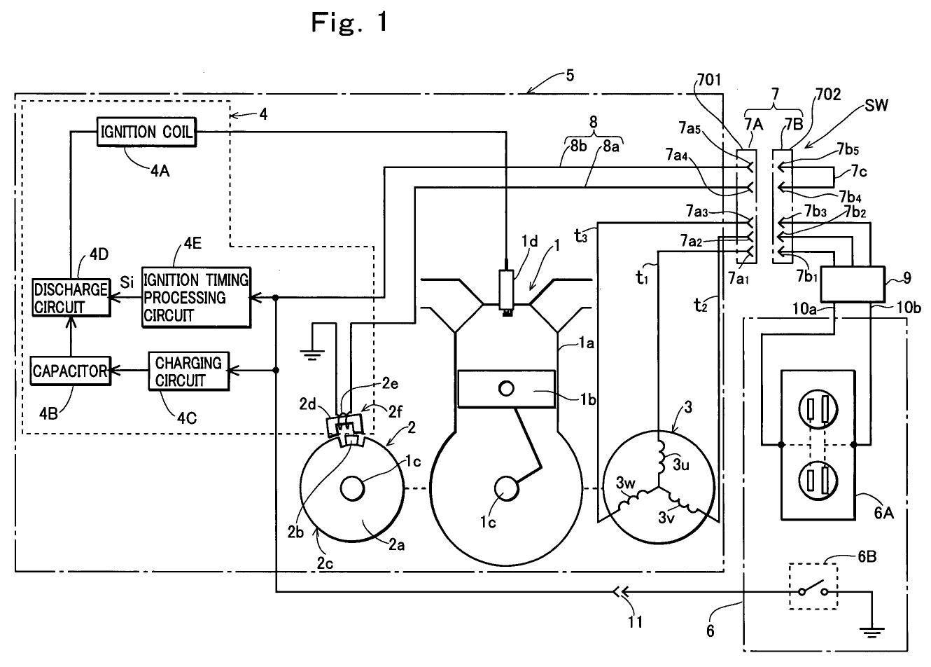

Now, preferred embodiments of the present invention will be described in detail with reference to the drawings. FIG. 1 shows a construction of a first embodiment of the present invention, and in FIG. 1, a reference numeral 1 denotes an engine including a cylinder 1a, a piston 1b, a crankshaft 1c, an ignition plug 1d, or the like, reference numerals 2 and 3 denote a first generator and a second generator driven by the engine 1, and a reference numeral 4 denotes an ignition device that ignites the engine 1.

The first generator 2 used in the embodiment is a magnetic AC generator including a magnet rotor 2c comprised by mounting a permanent magnet 2b to an outer periphery of a flywheel 2a mounted to the crankshaft 1c of the engine, and a stator 2f comprised by winding an exciter coil 2e around a core 2d having, at opposite ends thereof, magnetic pole portions that face magnetic poles of the magnet rotor 2c formed on the outer periphery of the flywheel. This generator induces an AC voltage in the exciter coil 2e in synchronization with a rotation of the engine 1.

The second generator 3 is a magnetic AC generator including a magnet rotor (not shown) comprised by mounting a permanent magnet to an inner periphery of a cup-like rotor yoke mounted to the crankshaft 1c of the engine 1, and a stator having three-phase generation coils 3u to 3w star connected. The second generator 3 induces three-phase AC voltages in the generation coils 3u to 3w in synchronization with the rotation of the engine.

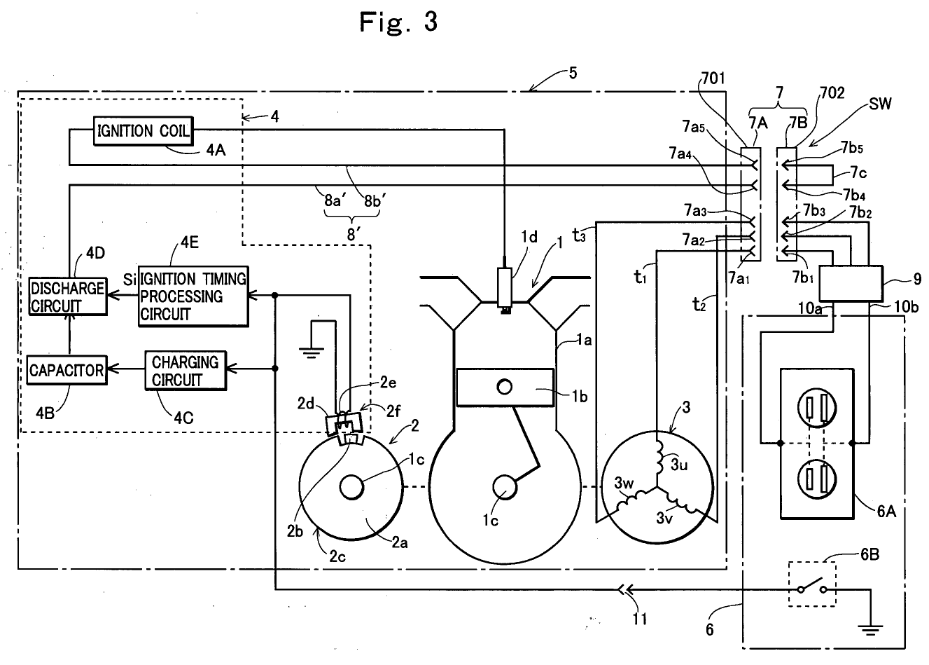

The generators 2 and 3 may be comprised as separate generators, or one generator using a cup-like flywheel 2a to use the flywheel 2a as a rotor yoke of the generator 3. When the generator 3 is comprised as a generator separated from the generator 2, the generator 3 may be a generator other than the magnetic AC generator, for example, an excitation synchronous generator. FIG. 1 shows the generator 3 including the three-phase generation coils 3u to 3w, but the generator 3 may output a single-phase AC voltage. In the present invention, any construction of the generator driven by the engine may be selected. The same applies to other embodiments shown in FIG. 3 and thereafter.

In this embodiment, a power supply device body 5 is comprised of the engine 1, the generators 2 and 3, and the ignition device 4. The power supply device body 5 further includes fuel supply means such as a fuel injection device or a carburetor for supplying fuel to the engine, and control means such as a microprocessor that comprises a control portion for controlling the engine and the generator, though not shown.

A reference numeral 6 denotes a panel portion of the engine driven power supply device, and in this panel portion, a load connection receptacle 6A used for connecting a plug connected to a load is provided, and operation switches and display lamps for various displays are also placed. In the shown embodiment, a stop switch 6B operated when the engine is stopped is provided as one of the operation switches.

A reference numeral 7 denotes a connector, and an output portion of the power supply device body 5 and the receptacle of the panel portion 6 are connected via the connector 7.

Any type of ignition device 4 that ignites the engine may be used, and in the shown embodiment, a capacitor discharge ignition device is used. The capacitor discharge ignition device includes an ignition coil 4A, a capacitor 4B provided on a primary side of the ignition coil 4A, a charging circuit 4C that charges the capacitor 4B to one polarity using the exciter coil 2e as a power supply, a discharge circuit 4D that discharges electric charges accumulated in the capacitor 4B through a primary coil of the ignition coil 4A when an ignition signal Si is provided, and an ignition timing processing circuit 4E that controls a timing to provide the ignition signal Si to the discharge circuit 4D using crank angle information of the engine, and induces a high voltage for ignition in a secondary coil of the ignition coil 4A by discharging the electric charges accumulated in the capacitor 4B. The high voltage induced in the secondary coil of the ignition coil is provided to the ignition plug 1d of the engine.

In the present invention, a connector state detection switch that enters different states between when the connector 7 is separated and when the connector 7 is connected is provided in the connector 7, wiring 8 required for holding electrical equipment required for maintaining an operation of the engine 1 in an operation state and the connector state detection switch are connected so that the connector state detection switch is inserted in the middle of the wiring 8, and the function of the electrical equipment is stopped when the connector 7 is separated. In the embodiment, the ignition device 4 is used as the electrical equipment.

Further describing in detail, the shown connector 7 is comprised of a first connector half 7A including first to fifth female contacts 7a1 to 7a5 in a first connector shell 701, and a second connector half 7B including first to fifth male contacts 7b1 to 7b5 connected to the first to fifth female contacts 7a1 to 7a5, respectively, in a second connector shell 702.

In the embodiment, the first to third female contacts 7a1 to 7a3 provided in the first connector half 7A are connected to output terminals t1 to t3 of the power supply device body drawn from terminals of the generation coils 3u to 3w opposite a neutral point, and the first to third male contacts 7b1 to 7b3 provided in the second connector half 7B are connected to an input terminal of a power conversion unit 9 via wires. The power conversion unit 9 is comprised of an inverter unit or a cyclone converter unit, and converts an output voltage of the generator 3 with variable frequencies and sizes according to rotational speeds of the engine 1 into a single-phase AC voltage with a fixed size and frequency. An output of the power conversion unit 9 is connected to the receptacle 6A via wires 10a and 10b. In the shown embodiment, the fourth and fifth male contacts 7b4 and 7b5 of the second connector half 7B are electrically connected by a jumper wire 7c inside or outside the connector shell 702, and a connector state detection switch SW that holds an ON state when the connector is connected (when the contacts 7a1 to 7a5 of the connector half 7A are connected to the contacts 7b1 to 7b5, respectively, of the connector half 7B) and holds an OFF state when the connector is separated (when the contacts 7a1 to 7a5 of the connector half 7A are separated from the contacts 7b1 to 7b5, respectively, of the connector half 7B) is comprised of the contacts 7a4 and 7a5, the contacts 7b4 and 7b5, and the jumper wire 7c.

In the shown embodiment, the exciter coil 2e serves as both an ignition power supply that supplies ignition energy to the ignition device 4 and a signal source that provides the crank angle information of the engine to the ignition device 4, and the output of the exciter coil 2e is provided to the charging circuit 4C and the ignition timing processing circuit 4E via wires 8a, 8b, the connector state detection switch SW comprised of the contacts 7a4, 7a5, 7b4 and 7b5 and the jumper wire 7c of the connector 7. In this embodiment, the wiring 8 that provides a signal including the crank angle information and the power supply voltage from the exciter coil 2e to the ignition device 4 is comprised of the wires 8a and 8b.

In the shown embodiment, one end of the stop switch 6B is grounded, and the other end of the stop switch 6B is connected to power supply input terminals of the charging circuit 4C and the ignition timing processing circuit 4E of the ignition device 4 via a connector 11. The stop switch 6B is a switch that is closed when the engine is stopped. When the stop switch 6B is closed, a short circuit is applied across the exciter coil 2e to stop the supply of the voltage from the exciter coil 2e to the ignition device 4, thereby stopping the operation of the ignition device 4.

Comprised as described above, the ignition device 4 required for maintaining the operation of the engine stops the operation thereof to stop the engine 1, thereby stopping the output of the generator 3 when the connector 7 is separated. This prevents electrical leakage or electrical shocks when the connector 7 is separated and a terminal thereof is exposed, thereby improving safety. Further, the engine 1 is stopped with the connector 7 being separated, thereby preventing energy from being wasted in a state where a load cannot be driven.

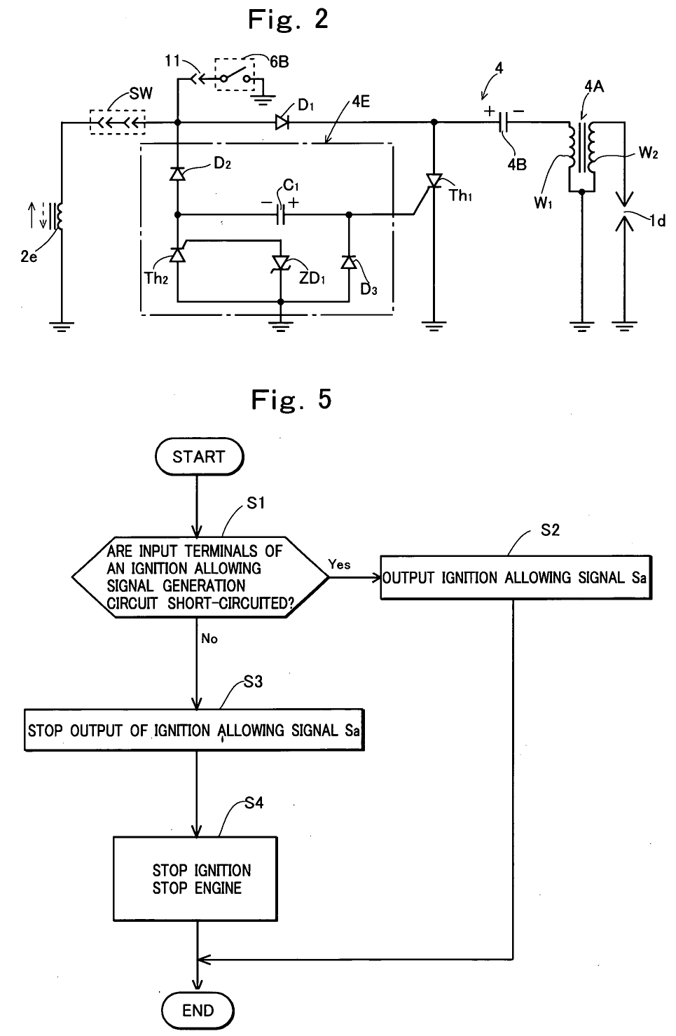

A construction example of the ignition device 4 used in the embodiment in FIG. 1 is shown in FIG. 2. The ignition coil 4A shown in FIG. 2 includes a primary coil W1 and a secondary coil W2 each having one end grounded, a terminal of the primary coil W1 opposite the ground is connected to one end of the capacitor 4B, and a terminal of the secondary coil W2 opposite the ground is connected to a terminal of the ignition plug 1d opposite the ground. The other end of the capacitor 4B is connected to an anode of a discharge thyristor Th1 having a cathode grounded, and the discharge circuit 4D shown in FIG. 1 is comprised of a closed circuit of the capacitor 4B—the thyristor Th1—the primary coil W1 of the ignition coil—and the capacitor 4B. One end of the exciter coil 2e is grounded, and the other end of the exciter coil is connected to the other end of the capacitor 4 via the switch SW provided in connector 7 and a diode D1 with an anode being directed to the switch. In this embodiment, the charging circuit 4C in FIG. 1 is comprised of a closed circuit of the exciter coil 2e—the diode D1—the capacitor 4B—the primary coil W1 of the ignition coil—the exciter coil 2e.

The ignition timing processing circuit 4E is comprised of a diode D2 having a cathode connected to a terminal of the exciter coil 2e opposite the ground via the switch SW provided in the connector 7, a capacitor C1 connected between an anode of the diode D2 and a gate of the thyristor Th1, a thyristor Th2 having a cathode connected to the anode of the diode D2 and an anode grounded, a Zener diode ZD1 having an anode connected to a gate of the thyristor Th2 and a cathode grounded, and a diode D3 connected between the gate of the thyristor Th1 and the ground with an anode being directed to the ground.

In the shown ignition device, the exciter coil 2e generates an AC voltage of one and a half cycle in which a voltage of a negative half wave in the direction of shown broken arrow, a voltage of a positive half wave in the direction of solid arrow, and a voltage of a negative half wave in the direction of broken arrow successively appear, once during one rotation of the crankshaft of the engine.

When the connector 7 is connected and the switch SW is in the ON state, a current passes through the charging circuit comprised of the closed circuit of the exciter coil 2e—the switch SW—the diode D1—the capacitor 4B—the primary coil W1 of the ignition coil—the exciter coil 2e at the voltage of the positive half wave in the direction of the shown solid arrow induced by the exciter coil 2e in synchronization with the rotation of the engine, and the capacitor 4B is charged to the shown polarity.

When the exciter coil 2e generates the voltage of the negative half in the direction of the shown broken arrow, a current passes through a circuit of the exciter coil 2e—the diode D3—the capacitor C1—the diode D2—the exciter coil 2e, and the capacitor C1 is charged to the shown polarity. When a voltage across the capacitor C1 reaches a set value, the Zener diode ZD1 conducts to provide a trigger signal to the thyristor Th2 to cause the thyristor Th2 to conduct, and thus electric charges in the capacitor C1 are discharged through a circuit between the gate and the cathode of the thyristor Th1 and through the thyristor Th2. The discharge from the capacitor C1 provides an ignition signal Si to the thyristor Th1 to cause the thyristor Th1 to conduct. When the thyristor Th1 conducts, electric charges in the capacitor 4B are discharged through the thyristor Th1 and the primary coil W1 of the ignition coil, thereby inducing a high voltage in the primary coil W1 of the ignition coil 4A. This voltage is stepped up by a step-up ratio between the primary coil and the secondary coil of the ignition coil, thereby inducing a high voltage for ignition in the secondary coil W2 of the ignition coil. The high voltage for ignition is applied to the ignition plug 1d, and thus spark discharge occurs in a discharge gap of the ignition plug 1d to ignite the engine. In the ignition device in FIG. 2, the voltage of the negative half wave in the direction of the shown broken arrow generated by the exciter coil 2e is used as a signal for providing the crank angle information of the engine. When the ignition device is comprised as shown in FIG. 2, the stop switch 6B shown in FIG. 1 is connected between the anode of the diode D1 and the ground.

In the shown embodiment, when the connector 7 is connected and the connector state detection switch SW provided in the connector is in the ON state, the engine is ignited as described above to maintain the operation of the engine. On the other hand, when the connector 7 is separated, the switch SW is in the OFF state to stop the charging of the capacitor 4B and the supply of the ignition signal to the thyristor Th1, and thus the ignition device 4 stops the ignition operation to stop the engine 1.

In the shown embodiment, the ignition timing processing circuit 4E is comprised of a hardware circuit, but the ignition timing processing circuit may be comprised using a microprocessor. In the shown embodiment, the engine includes a single cylinder, but, of course, the present invention may be applied to the case using a multicylinder engine.

In the above described embodiment, an electrical signal (the output of the exciter coil 2e) including the crank angle information of the engine is provided to the ignition device 4, and the connector state detection switch SW is inserted in the middle of the wiring 8 that provides the power supply voltage (the output voltage of the exciter coil) to the ignition device 4. When a signal source that provides a signal including the crank angle information to the ignition device 4 is provided separately from the exciter coil, however, the connector state detection switch SW may be inserted in the middle of either the wiring that provides the signal including the crank angle information to the ignition device or the wiring that provides the power supply voltage to the ignition device.

In the present invention, the connector state detection switch SW may be inserted in the middle of the wiring required for holding the electrical equipment required for maintaining the operation of the engine in the operation state, and the insertion position is not limited to the above described example. FIG. 3 shows a construction of a second embodiment of the present invention. In this embodiment, wiring 8′ for passing a primary current through an ignition coil 4A of an ignition device is comprised of wires 8a′ and 8b′, and a connector state detection switch SW is inserted in the middle of the wiring 8′. When the ignition device 4 is comprised as shown in FIG. 2, the connector state detection switch SW is inserted between a capacitor 4B and a primary coil W1 of the ignition coil, between the capacitor 4B and an anode of a thyristor Th1, or the primary coil W1 of the ignition coil and the ground. Other components of the power supply device in FIG. 3 are the same as in the first embodiment in FIG. 1.

In the embodiment in FIG. 3, when the connector 7 is correctly connected, the capacitor 4B can discharge through the primary coil of the ignition coil when a switch (the thyristor Th1 in the example in FIG. 2) provided in a discharge circuit 4D conducts, thereby allowing an ignition operation to be performed without any trouble to maintain the operation state of the engine. On the other hand, when the connector 7 is separated, the capacitor 4B cannot discharge through the primary coil of the ignition coil, thereby preventing the ignition operation from being performed to stop the engine.

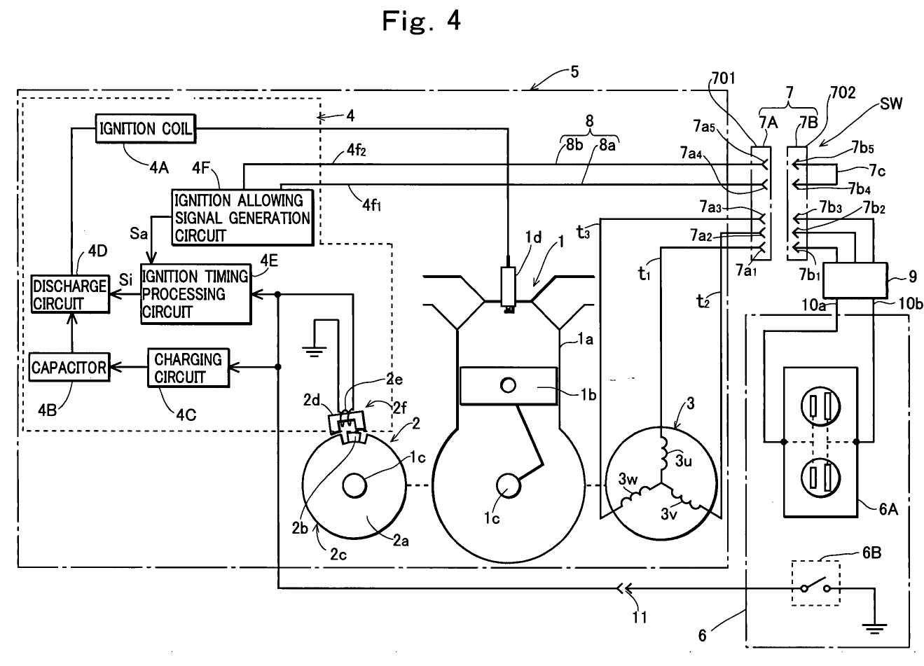

FIG. 4 shows a third embodiment of the present invention, and also in this embodiment, contacts 7b4 and 7b5 of a connector 7 are connected by a jumper wire 7c, and a connector state detection switch that holds an OFF state when the connector 7 is separated and holds an ON state when the connector 7 is connected is provided in the connector 7.

In this embodiment, an ignition allowing signal generation circuit 4F that has input terminals 4f1 and 4f2 and generates an ignition allowing signal Sa when the input terminals are short-circuited is provided in an ignition device 4, and the input terminals 4f1 and 4f2 are connected to fourth and fifth contacts 7a4 and 7a5 of a first connector half 7A via wires 8a and 8b, respectively, to connect the connector state detection switch SW between the input terminals 4f1 and 4f2. The ignition allowing signal Sa generated by the ignition allowing signal generation circuit 4F is input to the ignition timing processing circuit 4E. The ignition timing processing circuit 4E is comprised so as to generate an ignition signal Si at a predetermined timing when the ignition allowing signal Sa is provided and not to generate the ignition signal Si when the ignition allowing signal Sa is not provided. Specifically, the ignition device 4 is comprised so as to function (perform an ignition operation) only when the ignition allowing signal is generated.

The ignition allowing signal generation circuit 4F may be entirely comprised of a hardware circuit, or the ignition allowing signal generation circuit 4F may be comprised by a microprocessor to which a signal between the input terminals 4f1 and 4f2 is inputted and which executes a predetermined program.

FIG. 5 shows an algorithm of a task executed by the microprocessor at minimal time intervals when the ignition allowing signal generation circuit 4F is comprised using the microprocessor. According to the algorithm, first in Step S1, it is determined whether the input terminals 4f1 and 4f2 of the ignition allowing signal generation circuit 4F are short-circuited. When the connector 7 is connected, it is determined in Step S1 that the input terminals 4f1 and 4f2 are short-circuited. When it is determined in Step S1 that the input terminals are short-circuited, the process proceeds to Step S2 to generate an ignition allowing signal Sa to finish the task.

When the connector 7 is separated in the ignition device in FIG. 4, it is determined in Step 1 in FIG. 5 that the input terminals 4f1 and 4f2 of the ignition allowing signal generation circuit 4F are not short-circuited. When it is thus determined, the process proceeds from Step S1 to Step S3 to stop an output of the ignition allowing signal Sa, and stop the ignition operation in Step S4 to finish the task.

Thus, in the embodiment in FIG. 4, when the connector 7 is correctly connected, the ignition allowing signal generation circuit 4F generates the ignition allowing signal, thereby allowing the ignition operation to be performed without any trouble to maintain the engine 1 in the operation state. When the connector 7 is separated, the ignition allowing signal generation circuit 4F stops the generation of the ignition allowing signal, thereby preventing the ignition device 4 from performing the ignition operation to stop the engine.

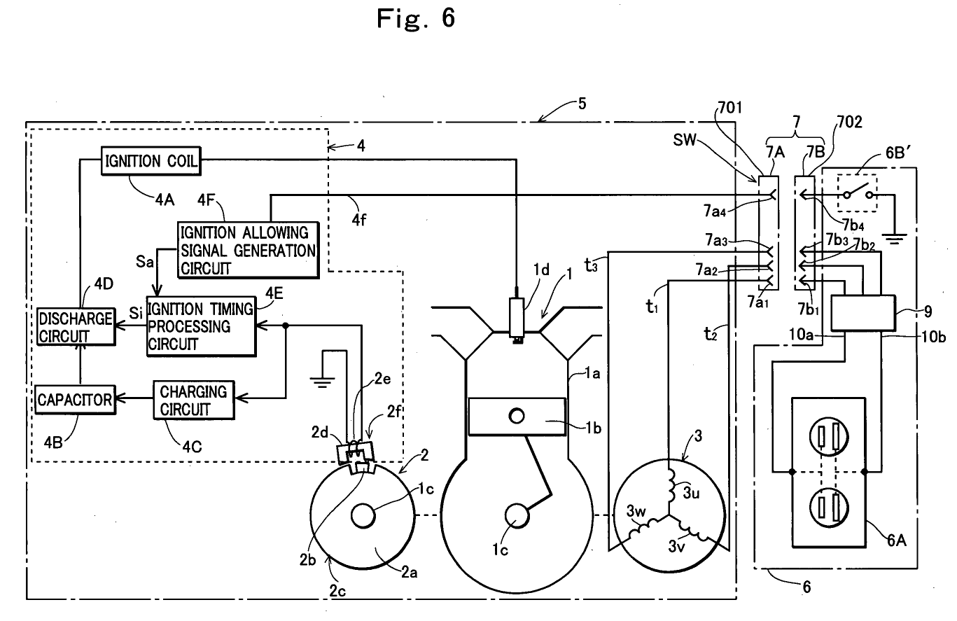

FIG. 6 shows a fourth embodiment of the present invention. In this embodiment, a connector 7 is comprised of a first connector half 7A including first to fourth female contacts 7a1 to 7a4 in a connector shell 701 and a second connector half 7B including first to fourth male contacts 7b1 to 7b4 connected to the contacts 7a1 to 7a4 in a connector shell 702. Also, three-phase output terminals t1 to t3 of a power supply device body are connected to the contacts 7a1 to 7a3, respectively, of the first connector half 7A, and the contacts 7b1 to 7b3 are connected to input terminals of a power conversion unit 9.

Also in this embodiment, a connector state detection switch SW that holds an OFF state when the connector 7 is separated and holds an ON state when the connector 7 is connected is comprised of the contacts 7a4 and 7b4 of the connector 7. An ignition allowing signal generation circuit 4F includes one input terminal 4f and is comprised so as to generate an ignition allowing signal Sa only when the input terminal 4f is connected to a ground circuit. The input terminal 4f of the ignition allowing signal generation circuit 4F is connected to the contact 7a4 of the first connector half 7A, and the contact 7b4 of the second connector half 7B is connected to the ground circuit via an operation switch 6B′ that is closed when the engine is operated. Specifically, the input terminal 4f of the ignition allowing signal generation circuit 4F is connected to the ground circuit via the connector state detection switch SW and the switch 6B′ that is closed when the engine is operated.

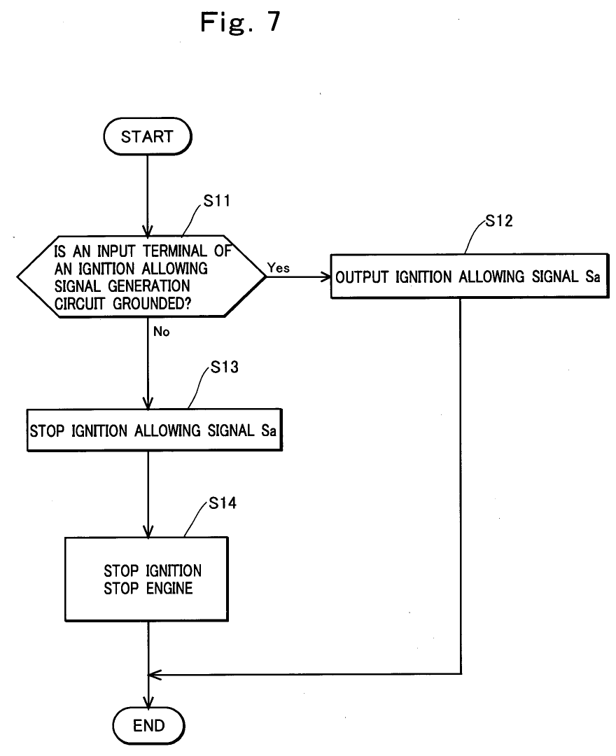

FIG. 7 shows a flowchart of an algorithm of a task executed by a microprocessor at minimal time intervals when the ignition allowing signal generation circuit 4F is comprised using the microprocessor in the embodiment in FIG. 6. According to the algorithm, in Step S11, it is determined whether the input terminal 4f of the ignition allowing signal generation circuit 4F is grounded. When the connector 7 is correctly connected, and the operation switch 6B′ is closed, it is determined in Step S11 that the input terminal 4f is grounded, and thus the process proceeds to Step S12 to generate an ignition allowing signal Sa to finish the task. When the connector 7 is separated, it is determined in Step S11 that the input terminal 4f of the ignition allowing signal generation circuit 4F is not short-circuited. When thus determined, the process proceeds to Step S13 to stop the generation of the ignition allowing signal, and stop the ignition operation in Step S14 to finish the task.

As described above, also in the embodiment in FIG. 6, when the connector 7 is connected, the ignition allowing signal generation circuit 4F generates the ignition allowing signal, thereby allowing the ignition operation to be performed without any trouble to maintain the engine 1 in the operation state. When the connector 7 is separated, the ignition allowing signal generation circuit 4F stops the generation of the ignition allowing signal, and thus the ignition device 4 stops the ignition operation to stop the engine. When the engine is stopped in a normal state where the connector 7 is connected, the operation switch 6B′ is opened to stop the generation of the ignition allowing signal to stop the ignition operation.

In the embodiments in FIG. 1 to FIG. 4, the connector state detection switch SW that holds the OFF state when the connector 7 is separated and holds the ON state when the connector 7 is connected is provided in the connector 7, but a connector state detection switch SW′ that holds an ON state when the connector 7 is separated and holds an OFF state when the connector 7 is connected may be provided in the connector 7. When such a connector state detection switch SW′ is provided in the connector, electrical equipment required for maintaining an operation of the engine when the connector state detection switch SW′ is in the ON state and the connector state detection switch are connected so that a component of the electrical equipment is short-circuited via the connector state detection switch SW′, and the function of the electrical equipment is stopped when the connector state detection switch is in the ON state.

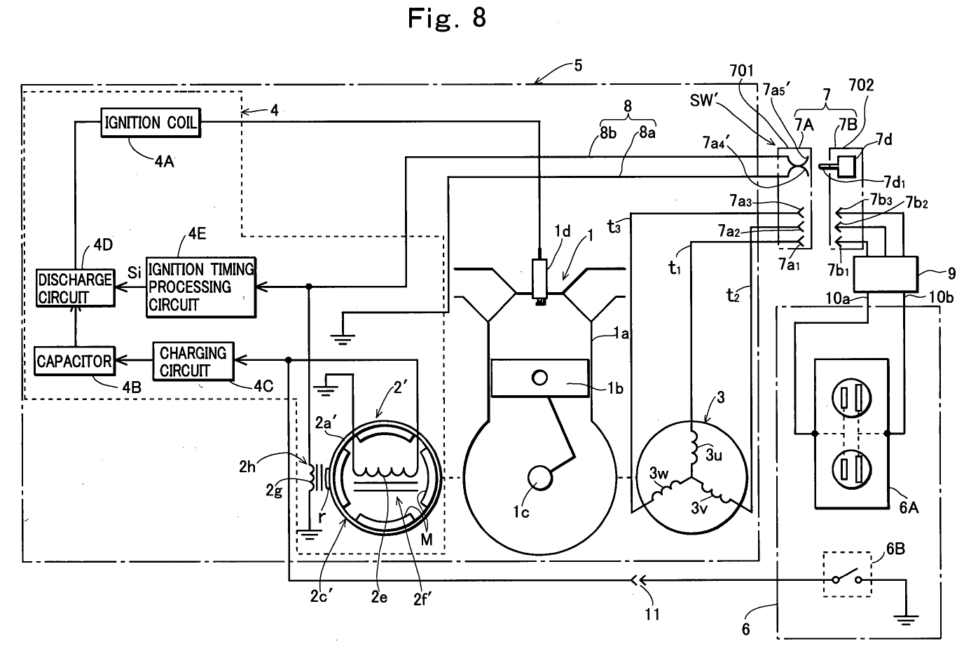

FIG. 8 shows a fifth embodiment of the present invention in which the connector state detection switch SW′ that holds the ON state when the connector 7 is separated and holds the OFF state when the connector 7 is connected is provided in the connector 7. In this embodiment, contacts 7a4′ and 7a5′ always held in contact with each other are provided in a first connector half 7A, and an operator 7d that is inserted between the contacts 7a4′ and 7a5′ when the connector 7 is connected and has an insulation protrusion 7d1 that electrically separates between the contacts 7a4′ and 7a5′ is provided in a second connector half 7B. In this embodiment, the connector state detection switch SW′ is comprised of the contacts 7a4′ and 7a5′ and the operator 7d.

In the embodiment in FIG. 8, a first generator 2′ is comprised of a magnet rotor 2c′ comprised by mounting a plurality of permanent magnets to an inner periphery of a cup-like rotor yoke 2a′ mounted to a crankshaft 1c of the engine, and a stator 2f having an exciter coil 2e. A reluctor r constituted by a protrusion is formed on an outer periphery of a rotor yoke 2a′ made of ferromagnetic material, and a pulser 2h including a signal coil 2g that generates pulses when a leading edge and a trailing edge of the reluctor in a rotational direction are detected is placed close to the outer periphery of the rotor yoke 2a′. The pulse generated by the signal coil 2g is input to an ignition timing processing circuit 4E as a signal including crank angle information of the engine, and a voltage induced in the exciter coil 2e is input to a charging circuit 4C as a power supply voltage. A terminal of the signal coil 2g opposite the ground is connected to the contact 7a5′, and the contact 7a4′ is connected to a ground circuit. Other constructions are the same as in the embodiment in FIG. 1. The ignition timing processing circuit 4E obtains rotational speed information of the engine from the pulse signal provided from the signal coil 2g to arithmetically operate an ignition timing at each rotational speed. The ignition timing processing circuit 4E also detects the arithmetically operated ignition timing using the crank angle information obtained from the pulse signal provided from the signal coil 2g, and generates an ignition signal Si when detecting the arithmetically operated ignition timing.

In the embodiment in FIG. 8, when the connector 7 is correctly connected, the connector state detection switch SW′ is held in the OFF state, and thus the pulse signal is provided from the signal coil 2g to the ignition timing processing circuit 4E, thereby allowing an ignition operation to be performed without any trouble. On the other hand, when the connector 7 is separated, the signal coil 2g is short-circuited via the connector state detection switch SW′ in the ON state, and thus the pulse signal output from the signal coil 2g is not provided to the ignition timing processing circuit 4E, thereby preventing the ignition operation from being performed.

In the embodiment in FIG. 8, a second generator 3 is provided, but may be omitted if a generation coil 3a that drives a load can be provided in the first generator 2′.

In the embodiment in FIG. 8, the component short-circuited via the connector state detection switch SW′ is a signal source (the signal coil 2g) that generates the electrical signal including the crank angle information of the engine, but the component short-circuited via the connector state detection switch SW′ may be a component that cannot maintain the operation of the engine when short-circuited and is not limited to the above described example. For example, the exciter coil 2e that is an ignition power supply that provides a power supply voltage to the ignition device 4 when the connector is separated may be short-circuited via the connector state detection switch SW′.

The object of the present invention may be also achieved by providing a connector state detection switch SW′ that holds an ON state when the connector 7 is separated and holds an OFF state when the connector 7 is connected in the connector 7, and comprising the ignition allowing signal generation circuit 4F so as to generate the ignition allowing signal when the input terminals 4f1 and 4f2 are open-circuited and not to generate the ignition allowing signal when the input terminals 4f1 and 4f2 are short-circuited in the embodiment in FIG. 4 as in the embodiment in FIG. 8.

The object of the present invention may be also achieved by comprising the ignition allowing signal generation circuit 4F so as to generate the ignition allowing signal when the input terminal 4f is separated from the ground circuit and stop the generation of the ignition allowing signal when the input terminal 4f is connected to the ground circuit using the connector 7 as in the embodiment in FIG. 8 in the embodiment in FIG. 6, and connecting the input terminal 4f to the ground circuit via the connector state detection switch SW′.

If the operation switch 6B′ is connected to the input terminal of the ignition allowing signal generation circuit via the connector 7 as in the embodiment in FIG. 6, the connector 11 used in the embodiment in FIG. 1 can be omitted, but in the embodiment in FIG. 6, a switch similar to the stop switch 6B used in the embodiment in FIG. 1 may be used. In this case, the contact 7b3 of the connector 7 in FIG. 6 may be directly connected to the ground circuit.

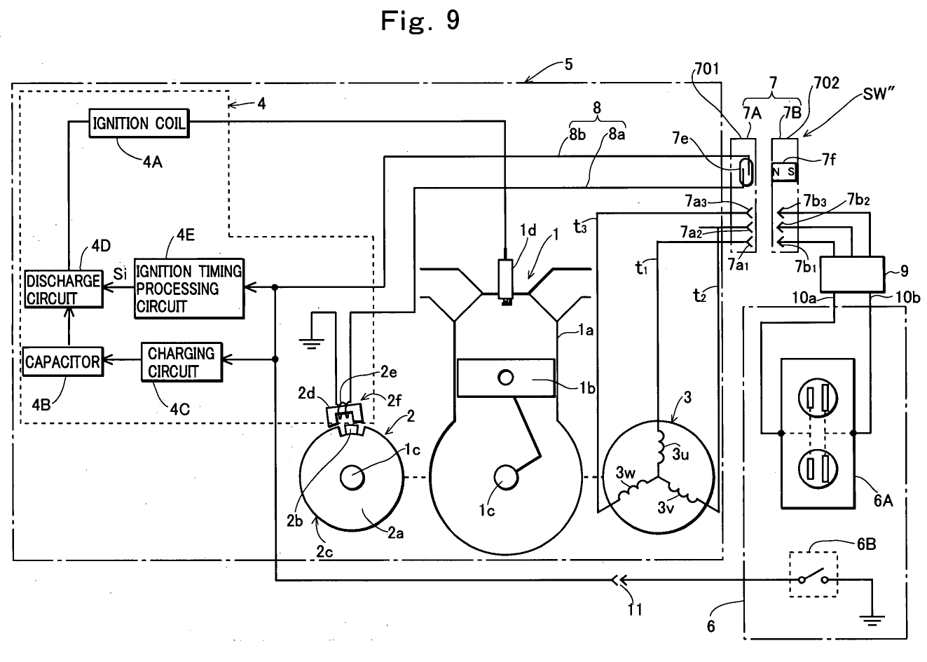

In each of the above described embodiments, the connector state detection switch provided in the connector 7 is comprised using the contact of the connector, but the present invention is not limited to the case of comprising the connector state detection switch in this way. For example, as shown in FIG. 9, a lead switch 7e may be placed in the connector shell 701 of the first connector half 7A, and a magnet 7f that drives the lead switch may be placed in the connector shell 702 of the second connector half 7B, so that the lead switch 7e is in an ON state when the connector 7 is connected, and the lead switch 7e is in an OFF state when the connector 7 is separated. In this example, a connector state detection switch SW″ is comprised of the lead switch 7e and the magnet 7f. Other constructions of the embodiment in FIG. 9 are the same as in the embodiment in FIG. 1, and an output of an exciter coil 2e is input to an ignition timing processing circuit 4E and a charging circuit 4C via the lead switch 7e.

In each of the above described embodiments, the power supply device that directly supplies the output of the AC generator 3 to the load is taken as an example. The present invention may be, however, applied to the case where a power supply device body is comprised so as to use, as a power supply, an inverter generator that once converts an output of an AC generator driven by an engine into a DC output and then converts the DC output into an AC voltage at a fixed frequency using an inverter, or the case where a power supply device body is comprised so as to convert an output of an AC generator driven by an engine into an AC voltage at a fixed frequency using a cyclone converter.

In each of the above described embodiments, the magnetic AC generator that requires changing the rotational speed for adjusting the output is used as the generator 3 driven by the engine, and thus the output of the generator 3 is input to the power conversion unit 9, converted to the AC voltage with the fixed frequency and size, and then supplied to the load. However, in the case where an excitation AC generator is used as the generator 3 driven by the engine, the rotational speed of the engine is controlled so that an output frequency is fixed, and an excitation current of the generator is controlled so that an output voltage is fixed, a construction of directly supplying the output of the generator to the load may be achieved without providing a power conversion unit.

Although a preferred embodiment of the invention has been described and illustrated with reference to the accompanying drawings, it will be understood by those skilled in the art that it is by way of example, and that various changes and modifications may be made without departing from the spirit and scope of the invention, which is defined only to the appended claims.

What is claimed is:

1. An engine driven power supply device comprising:
a power supply device body that outputs power required for driving a load using a generator driven by an engine as a power supply; and
a load connecting receptacle connected to an output end of said power supply device body via a connector,
wherein a connector state detection switch that enters different states between when said connector is separated and when said connector is connected is provided in said connector, and
an electrical equipment required for maintaining an operation of said engine and said connector state detection switch are connected so that the function of said electrical equipment is stopped when said connector is separated.

2. An engine driven power supply device comprising:
a power supply device body that outputs power required for driving a load using a generator driven by an engine as a power supply; and
a load connecting receptacle connected to an output end of said power supply device body via a connector,
wherein a connector state detection switch that holds an OFF state when said connector is separated and holds an ON state when said connector is connected is provided in said connector,
wiring required for holding electrical equipment required for maintaining an operation of said engine in an operation state and said connector state detection switch are connected so that said connector state detection switch is inserted in the middle of the wiring, and the function of said electrical equipment is stopped when the connector state detection switch is in the OFF state.

3. The engine driven power supply device according to claim 2, wherein said electrical equipment is an ignition device that ignites said engine, and
said wiring into which said connector state detection switch is inserted is wiring that provides an electrical signal including crank angle information of said engine to said ignition device.

4. The engine driven power supply device according to claim 2, wherein said electrical equipment is an ignition device that ignites said engine, and
said wiring into which said connector state detection switch is inserted is wiring for supplying a power supply voltage to said ignition device.

5. The engine driven power supply device according to claim 2, wherein said electrical equipment is an ignition device that ignites said engine, and
said wiring into which said connector state detection switch is inserted is wiring for passing a primary current through an ignition coil of said ignition device.

6. An engine driven power supply device comprising:
a power supply device body that outputs power required for driving a load using a generator driven by an engine as a power supply; and
a load connecting receptacle connected to an output end of said power supply device body via a connector,
wherein a connector state detection switch that holds an ON state when said connector is separated and holds an OFF state when said connector is connected is provided in said connector,
an electrical equipment required for maintaining an operation of said engine and said connector state detection switch are connected so that some components of said electrical equipment are short-circuited via said connector state detection switch when said connector state detection switch is in the ON state, and the function of said electrical equipment is stopped when said connector state detection switch is in the ON state.

7. The engine driven power supply device according to claim 6, wherein said electrical equipment is an ignition device that ignites said engine, and
the component short-circuited via said connector state detection switch is a signal source that generates an electrical signal including crank angle information of said engine.

8. The engine driven power supply device according to claim 6, wherein said electrical equipment is an ignition device that ignites said engine, and
the component short-circuited via said connector state detection switch is an ignition power supply that supplies a power supply voltage to said ignition device.

9. An engine driven power supply device comprising:
a power supply device body that outputs power required for driving a load using a generator driven by an engine as a power supply; and
a load connecting receptacle connected to an output end of said power supply device body via a connector,
wherein a connector state detection switch that holds an OFF state when said connector is separated and holds an ON state when said connector is connected is provided in said connector,
an ignition allowing signal generation circuit that generates an ignition allowing signal when input terminals are short-circuited is provided,
an ignition device that ignites said engine is comprised so as to function only when said ignition allowing signal is generated,
said connector state detection switch is connected between the input terminals of said ignition allowing signal generation circuit, and the input terminals of said ignition allowing signal generation circuit are short-circuited when said connector is connected.

10. An engine driven power supply device comprising:
a power supply device body that outputs power required for driving a load using a generator driven by an engine as a power supply; and
a load connecting receptacle connected to an output end of said power supply device body via a connector,
wherein a connector state detection switch that holds an OFF state when said connector is separated and holds an ON state when said connector is connected is provided in said connector,
an ignition allowing signal generation circuit that generates an ignition allowing signal only when an input terminal is connected to a ground circuit is provided,
an ignition device that ignites said engine is comprised so as to function only when said ignition allowing signal is generated, and
the input terminal of said ignition allowing signal generation circuit is connected to the ground circuit via said connector state detection switch.

11. An engine driven power supply device comprising:
a power supply device body that outputs power required for driving a load using a generator driven by an engine as a power supply; and
a load connecting receptacle connected to an output end of said power supply device body via a connector,
wherein a connector state detection switch that holds an ON state when said connector is separated and holds an OFF state when said connector is connected is provided in said connector,
an ignition allowing signal generation circuit that generates an ignition allowing signal when input terminals are open-circuited,
an ignition device that ignites said engine is comprised so as to function only when said ignition allowing signal is generated,
said connector state detection switch is connected between the input terminals of said ignition allowing signal generation circuit, and the input terminals of said ignition allowing signal generation circuit are open-circuited when said connector is connected.

12. An engine driven power supply device comprising:
a power supply device body that outputs power required for driving a load using a generator driven by an engine as a power supply; and
a load connecting receptacle connected to an output end of said power supply device body via a connector,
wherein a connector state detection switch that holds an ON state when said connector is separated and holds an OFF state when said connector is connected is provided in said connector,
an ignition allowing signal generation circuit that generates an ignition allowing signal when an input terminal is separated from a ground circuit and stops the generation of said ignition allowing signal when said input terminal is connected to the ground circuit is provided,
an ignition device that ignites said engine is comprised so as to function only when said ignition allowing signal is generated, and
the input terminal of said ignition allowing signal generation circuit is connected to the ground circuit via said connector state detection switch.
